(19) United States
(12) Patent Application Publication
(10) Pub. No.: US 2010/0102583 A1
(43) Pub. Date: Apr. 29, 2010

(54) EXTENDIBLE REACHER

(76) Inventors: Cody McCoy, Mesa, AZ (US); Gregory J. Bruni, Phoenix, AZ (US)

Correspondence Address: BUTZEL LONG;IP DOCKETING DEPT, 350 SOUTH MAIN STREET, SUITE 300, ANN ARBOR, MI, 48104, US

(21) Appl. No.: 12/605,646

(22) Filed: Oct. 26, 2009

Related U.S. Application Data
(60) Provisional application No. 61/108,295, filed on Oct. 24, 2008.

(51) Int. Cl. B25J 1/00; B25J 1/04; A47F 13/06

(52) U.S. Cl. 294/19.1

(57) ABSTRACT

A hand-held reacher, comprising a jaw portion having a pair of jaws movable relative to each other between fully clamped and fully opened positions thereof, and a handle portion spaced apart from the jaw portion by a selectively extendible central portion. The handle portion comprises a manually-actuatable trigger operatively connected to the jaw portion by a selectively extendible pull member at least substantially disposed within the central portion, whereby actuation of the trigger is operative to move the pull member to thereby selectively position the pair of jaws between the fully clamped and fully opened position thereof. The selectively extendible central portion comprises a first tubular member slidingly telescopingly received within a second tubular member, a first coupling for selectively fixing the relative positions of the first and second tubular members, and a second coupling for selectively fixing the length of the pull member, the second coupling being characterized by a first, engaged condition in which the length of the pull member is fixed, and a second, disengaged condition in which the length of the pull member may be varied.

### CROSS-REFERENCE TO RELATED APPLICATIONS

This application is related to, and claims the benefit of priority from, U.S. Provisional Patent Application Ser. No. 61/108,295, filed 24 Oct. 2008, the disclosure of which application is incorporated herein by reference in its entirety.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISC

Not applicable.

### FIELD OF THE INVENTION

The present invention pertains generally to hand-held devices used for gripping or picking up objects, commonly referred to as “reachers,” and more particularly to a reacher having the handle and jaw portions spaced apart from each other by an extendible central portion.

### BACKGROUND OF THE INVENTION

In their most elemental form, comprising a jaw portion and a handle portion spaced apart by a central portion, hand-held reachers for picking up and gripping objects have been known for years. In the past, reachers have been largely characterized by fixed-length central portions. More recently, however, there have been disclosed reachers with adjustable-length central portions whereby a reacher's overall length is extendible. The disclosures of Hsu, U.S. Pat. No. 6,513,844, No. 6,520,556, and No. 6,739,637, all of which are incorporated herein by reference in their entireties, are exemplary in these regards. While providing for adjustments in the overall length of the reacher, these known extendible reachers could be improved upon.

### SUMMARY OF THE DISCLOSURE

The specification describes a hand-held reacher, comprising a jaw portion having a pair of jaws movable relative to each other between fully clamped and fully opened positions thereof, and a handle portion spaced apart from the jaw portion by a selectively extendible central portion. The handle portion comprises a manually-actuatable trigger operatively connected to the jaw portion by a selectively extendible pull member at least substantially disposed within the central portion. Actuation of the trigger is operative to move the pull member to thereby selectively position the pair of jaws between the fully clamped and fully opened position thereof. The selectively extendible central portion comprises a first tubular member slidingly telescopingly received within a second tubular member. A first coupling selectively fixes the relative positions of the first and second tubular members, and a second coupling selectively fixes the length of the pull member. The second coupling is characterized by a first, engaged condition in which the length of the pull member is fixed, and a second, disengaged condition in which the length of the pull member may be varied.

A user-actuatable trigger is, in one embodiment, positioned remotely from the second coupling and operatively connected to the second coupling permits selectively variation of the second coupling between the first and second conditions thereof.

According to this embodiment, the pull member may comprise a first pull tube slidingly telescopingly received within a second pull tube, and the second coupling comprises a selectively radially expandable mandrel disposed within the second pull tube, the mandrel being characterized by a first, engaged condition in which the mandrel is radially expanded into engagement with the interior surface of the second pull tube to thereby fix the length of the pull member, and a second, disengaged condition in which the mandrel is radially contracted out of engagement with the interior surface of the second pull tube to thereby permit the length of the pull member to be varied. Per one feature, the user-actuatable trigger may comprises a manually operable release trigger positioned on the second tubular member proximate the handle, the release trigger being operatively connected to the expanding mandrel via a connecting rod. According to another feature of the first embodiment, the radially expandable mandrel comprises a mandrel body having a tapered interior passageway, a plurality of radially-moveable elements disposed about the exterior circumference of the mandrel body, and a tapered wedge dimensioned for movement within the tapered interior passageway of the mandrel body. Per another aspect of this embodiment, the connecting rod of the user-actuatable trigger is connected to the tapered wedge, and actuation of the user-actuatable trigger is operative to move the tapered wedge within the interior passageway of the mandrel body.

Per another form of this first embodiment of the present inventive reacher, the pull member comprises first and second pull rods, and the second coupling comprises a cam body supporting a cam. The first pull rod is fixedly connected to the cam support body, and the second pull rod is slidingly associated with the cam support body. The cam is characterized by a first, engaged condition in which the cam is in contact with the second pull rod to thereby fix the length of the pull member, and a second, disengaged condition in which the cam is out of contact with the second pull rod to thereby permit the length of the pull member to be varied. According to one aspect, the user-actuatable trigger comprises a manually operable release trigger provided on the handle portion, the release trigger being operatively connected to the cam via a connecting rod. Per another feature, the cam body includes a first passageway through which is slidingly received the second pull rod. The cam is pivotally mounted on the cam body, and the passageway includes an opening through which the cam can be brought into engagement with the second pull rod in the first, engaged position of the first coupling. Per still another feature, the cam is biased toward engagement with the second pull rod via the opening in the cam body, and actuation of the user-actuatable trigger is operative to move the cam out of the passageway opening in the cam body and out of engagement with the second pull rod.

According to another embodiment of the invention, selective positioning of the second coupling between the first and second conditions thereof is effected by rotational movement of one of the first or second tubular members of the central portion. Per this embodiment, the pull member may comprise a pull rod and a toothed gear rack, and the second coupling comprises a toothed lock member. The pull rod is fixedly connected to the toothed lock member. In the first, engaged condition of the second coupling the toothed lock member is in contact with the toothed gear rack to thereby fix the length of the pull member, and in the second, disengaged condition of the second coupling the toothed lock member is out of contact with the toothed gear rack to thereby permit the length of the pull member to be varied. According to one feature of this embodiment, the pull rod is operatively connected to the manually-actuatable trigger, and the gear rack is operatively connected to the jaw portion. Per still another feature of this embodiment of the invention, the gear rack is slidably received in, and rotatably fixed relative to, a housing disposed within, and rotatably fixed relative to, one of the first or second tubular members of the central portion. Rotational movement of one of the first or second tubular members of the central portion in a first direction is operative to rotate the housing and carry toothed gear rack out of engagement with the toothed locking member to thereby define the second condition of the second coupling, and rotational movement of the said one of the first or second tubular members of the central portion in a second direction is operative to rotate the housing and carry toothed gear rack into from a position of disengagement with the toothed locking member back into engagement with the toothed locking member to thereby define the first condition of the second coupling. Per yet another aspect of this embodiment, the locking member is positioned within the housing.

According to one feature of the invention, the first coupling for selectively fixing the relative positions of the first and second tubular members comprises a collet disposed proximate an end of the first tubular member, and a collet nut threadingly engageable thereon.

### BRIEF DESCRIPTION OF THE DRAWINGS

Other advantages of the present invention will be readily appreciated as the same becomes better understood by reference to the following detailed description when considered with the accompanying drawings, wherein:

FIG. 1 comprises a lateral perspective view of an extendible reacher according to the present invention;

FIG. 2 is an exploded view of the jaw portion of the inventive reacher;

FIG. 3 is a lateral cut-away view of the jaw portion;

FIG. 4 comprises an exploded view of the handle portion of the inventive reacher according to a first form of a first embodiment thereof;

FIG. 5 is a lateral cut-away view of the handle portion according to the form of FIG. 4;

FIG. 6 is an exploded view of the central portion of the inventive reacher according to the a first form thereof;

FIG. 7 comprises a lateral cut-away view of the central portion according to the form of FIG. 6;

FIG. 7a depicts, in a detailed, partially exploded view, an alternative embodiment of means to selectively fix the relative positions of the first and second tubular members;

FIG. 8 comprises a lateral, cut-away view of an extendible reacher according to a second form of the first embodiment of the present invention;

FIG. 9 is a lateral cut-away view of the handle portion according to the second form;

FIG. 10 comprises a perspective view of the second coupling and user-actuatable trigger according to the second form of the present invention;

FIG. 11 comprises a detailed, cut-away perspective view of the second coupling of the second form of the present invention;

FIG. 12 comprises a detailed perspective view of the second coupling of FIG. 11;

FIG. 13 is a perspective view showing a portion of the second coupling of FIGS. 11 and 12;

FIG. 14 comprises a lateral, cut-away view of an extendible reacher according to a second embodiment of the present invention;

FIG. 15 is a perspective view of the locking member of the exemplary form of the second embodiment of the invention;

FIG. 16 is a perspective view of the gear rack which comprises the pull member of the second embodiment of the present invention;

FIG. 17 is an exploded perspective view of the locking sleeve of the embodiment of FIG. 14;

FIG. 18 is a cross-sectional view of the second tubular member;

FIG. 19 is a cross-sectional view of the tubular member of the locking sleeve;

FIG. 20a is a perspective view showing the second coupling member of the second embodiment of the invention in the engaged condition thereof;

FIG. 20b is a perspective view showing the second coupling member of the second embodiment of the invention in the disengaged condition thereof; and

FIGS. 21a and 21b depict in cross-section an alternative embodiment of a handle portion in two operational states (jaws fully open and jaws fully closed).

### WRITTEN DESCRIPTION

As required, detailed embodiments of the present invention are disclosed herein. However, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for teaching one skilled in the art to variously employ the present invention.

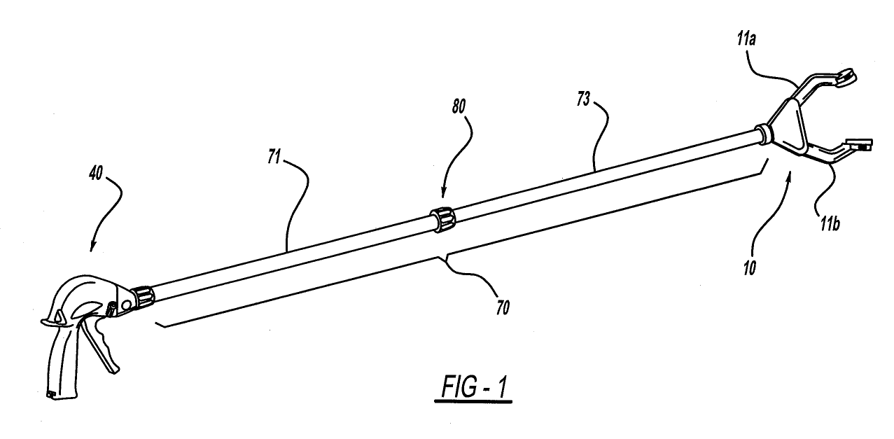

Referring to the drawings, wherein like numerals indicate like or corresponding parts throughout the several views, the present invention will be seen to generally comprise a hand-held reacher having a jaw portion (indicated generally at 10) comprising a pair of jaws 11a, 11b and a handle portion (indicated generally at 40) spaced apart by a selectively extendible central portion (indicated generally at 70). FIG. 1. In order to permit actuation of the jaw portion 10 in the plurality of possible lengths of the extendible central portion 70, the handle portion 40 comprises a manually-actuatable trigger 41 operatively connected to the jaws of the jaw portion by a telescopingly adjustable pull member (not shown in FIG. 1). Actuation of the trigger 41 is operative to move the pull member to thereby selectively position the pair of jaws 11a, 11b between fully clamped and fully opened positions thereof.

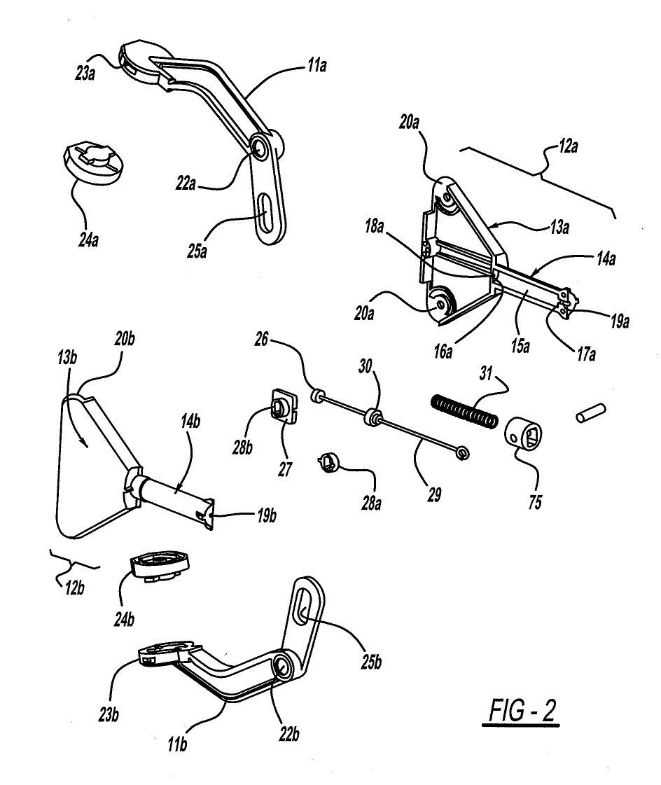

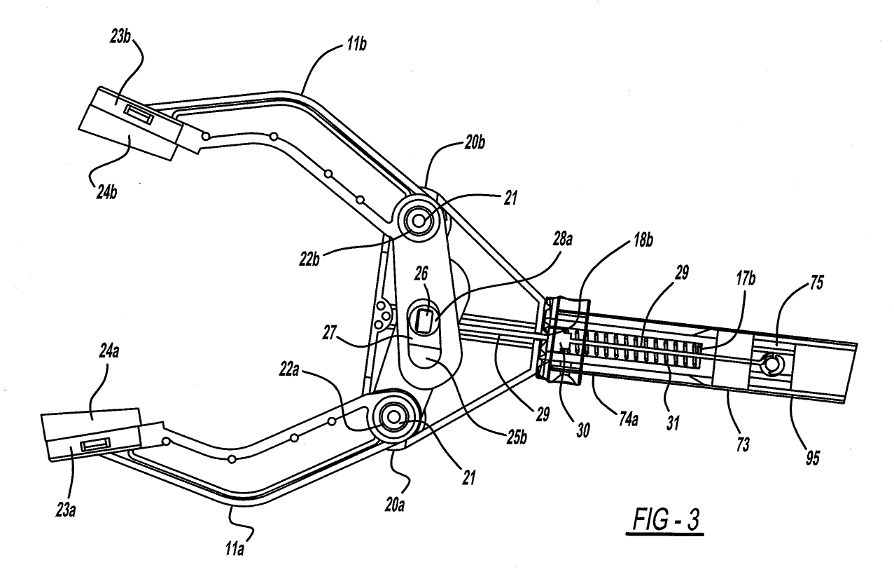

Referring also to FIGS. 2 and 3, both of which detail the construction of an exemplary jaw portion, the same may be seen to be generally of conventional construction and include, according to the illustrated embodiment, a housing that may be made in two mateable halves 12a, 12b secured together by fasteners, adhesive, etc. Housing halves 12a, 12b are, except as otherwise noted, essentially mirror-images of one another, and each is generally comprised of a jaw-housing portion 13a, 13b and a neck portion 14a, 14b. Using the housing half 12a as exemplary of both halves, the neck portion 14a defines an interior channel 15a terminating at opposite ends in stop surfaces 16a and 17a. Stop surfaces each have a channel 18a and 19a defined therethrough, these channels being coaxial. In the assembled housing, formed by mating the housing halves 12a, 12b, channels 15a, 15b in each of the housing halves collectively define a generally cylindrically-shaped internal passageway communicating with smaller-diameter openings through opposite end walls defined by the channels 18a, 18b and 19a, 19b defined through the stop surfaces.

Furthermore, in the assembled housing the neck portions 14a, 14b of each housing half 12a, 12b collectively define a generally cylindrically-shaped stem dimensioned to be received within and interconnected to the central portion 70 as hereafter described.

Still referring to jaw-housing half 12a as exemplary of both housing halves, openings 20a, 20b at the corners of the jaw housing portions 13a, 13b provide clearance for the jaws 11a, 11b to protrude therefrom. Referring particularly to FIG. 3, which details the housing half 12b, pivot posts 21 are mounted near each of the corners 20b of only the mateable half 12b, and the jaws 11a, 11b are each provided with bores 22a, 22b therethrough dimensioned for the jaws to be mounted one upon each post 21.

Portions of jaws 11a, 11b extend away from the jaw housing, terminating in end effectors 23a, 23b having gripping portions 24a, 24b.

Portions of jaws 11a, 11b also extend into the jaw housing defined by housing halves 12a, 12b, these interior portions being, as shown, reduced in thickness relative to the remainder of the jaws and interleaved to achieve an overlapping configuration. Each such interior portion is provided with a slot 25a, 25b, which slots also overlap to define a communicating opening. In order to effect simultaneous movement of the jaws 11a, 11b, a carriage assembly is disposed within the slots 25a, 25b and between the interior portions of the jaws.

As shown best in FIG. 2, the carriage assembly comprises a pull rod end boss 26, rack 27, and a lug comprised of portions 28a, 28b. End boss 26 is disposed on an end of a carriage assembly pull rod 29. Rack 27 contains a central recessed portion to accommodate the rod 29 and lug portion 28a, 28b. A rectangular aperture is provided through the center of this recessed portion to accommodate end boss 26. Each lug portion 28a, 28b is also provided with a substantially rectangular aperture to accommodate end boss 26. The apertures in rack 27 and lug portions 28a, 28b, as well as the recessed portion in rack 27 to accommodate rod 29, should be sized to allow the free rotation of end boss 26 and rod 29 when fully assembled. Assembled, lug portions 28a, 28b cooperate with one of the slots 25a, 25b in jaws 11a, 11b, respectively, to complete the mechanical connection between jaws 11a, 11b and rod 29.

Still referring to FIG. 2, a second boss 30 is attached to rod 29 at a sufficient distance away from end boss 26 to dispose second boss 30 within the generally cylindrical chamber defined in the assembled housing by the channels 15a, 15b of the neck portions of the housing halves 12a, 12b. A helical spring 31 is disposed within this chamber coaxial with rod 29 and abutting second boss 30 on one end and the end wall defined by the stop surfaces 17a, 17b of the housing halves 12a, 12b at its other end.

It will be understood that the foregoing jaw portion construction is intended as exemplary only, and that those of skill in the art are free to adapt the jaw portion construction as desired, consistent only with facilitating operation of the extendible nature of the reacher as hereinafter described.

Referring now to FIGS. 1, 4 and 5, the exemplary handle portion 40 is shown to comprise mateable housing halves 42a, 42b which movably support the manually-actuatable trigger 41. The mateable housing halves 42a, 42b are, except as otherwise noted, essentially mirror-images of one another, and may be secured together with fasteners, adhesive, or other known means to define an unitary housing for the trigger 41.

Trigger 41 is pivotally mounted to trigger pivot shaft 43 provided on one of the housing halves (42a as shown). Trigger 41 includes an opening 44 therethrough to accommodate a trigger-connecting pull rod 45, a locking tab 46 secured in place by pin 47, and a lock lever 48 which requires free movement within the opening 44. Trigger-connecting pull rod 45 includes an eyelet 49 by which the rod is connected to the trigger with a pin 50 as shown.

In order to selectively fix the pivotal position of the trigger 41, and thereby fix the relative positions of the jaws 11a, 11b between the fully open and fully closed positions thereof, the reacher may, as desired, be provided with a locking mechanism. The mechanism as shown in the exemplary embodiment includes lock lever 48 mounted on lock arm pivot pin 51. The proximal end of lock lever 48 is attached by way of spring 52 to a post 53 provided on one of the housing halves (42a as shown).

The lock lever 48 features a first end having a variable geometry interface comprising first 54 and second 55 cam surfaces. Opposite the cam surfaces 54, 55, lock lever 48 is provided with a plurality of locking teeth 56 which are selectively engageable with the locking tab 46 disposed on trigger 41 within the opening 44. Interfacing with cam surfaces 54, 55 is a cam roller assembly comprising a cam roller support 57 mounting a cam roller 58. Cam roller support 57 is pivotally captured between housing halves 42a, 42b. Manually-actuatable toggle levers 59 disposed on the exterior of each of the handle mateable halves 42a, 42b are connected to the cam roller support 57 through the walls of the housing halves 42a, 42b, such as by means of screws 60, as shown. By this interconnection, selective pivotal movement of either toggle lever 59 effects corresponding pivotal movement of cam roller support 57 to bring cam roller into engagement with one or the other of cam surfaces 54, 55. More particularly, when cam roller 58 is brought into engagement with the first cam surface 54, the lock lever 48 is urged by the biasing action of spring 52 into a position where the locking teeth 56 are successively engageable by the locking tab 46 as the trigger 41 is moved rearwardly away from the jaw portion. Conversely, when the cam roller 58 is brought into engagement with the second cam surface 55, the lock lever 48 is urged away from its spring-biased position and into a position where the locking teeth 56 are positioned out of the path of travel of, and so cannot be engaged by, the locking tab 46 as the trigger 41 is moved rearwardly. In this configuration, it will be appreciated that the trigger 41 is free to move both rearwardly and forwardly without interference.

It will be understood that the foregoing handle portion construction is intended as exemplary only, and that those of skill in the art are free to adapt the handle portion construction as desired, consistent only with facilitating operation of the extendible nature of the reacher as hereinafter described.

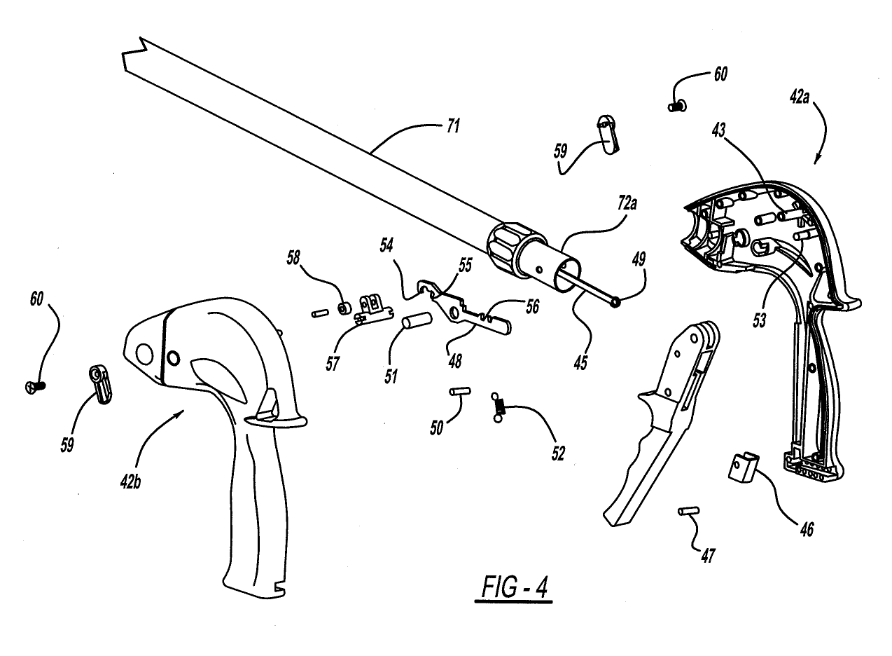

With reference next being had to FIGS. 1, 6 and 7, the central portion 70 in all embodiments of the invention herein described comprises a first tubular member 71 with opposite first 72a and second 72b ends, the first end connected to the handle portion 40 (see also FIGS. 4 and 5), and a second tubular member 73 having opposite first 74a and second 74b ends. As shown in FIG. 3, the stem of jaw portion 10 defined by the neck portions of housing halves 12a, 12b is received within the first end 74a of the second tubular member 73, being retained thereon by the interconnection of an eyelet end of carriage assembly pull rod 29 with a mount 75 secured in an end of second pull tube 95. As desired, the jaw portion 10 may be rotatably connected to the second tubular member 73 in a manner such as described in U.S. Pat. No. 7,344,171, which disclosure is incorporated herein by reference in its entirety.

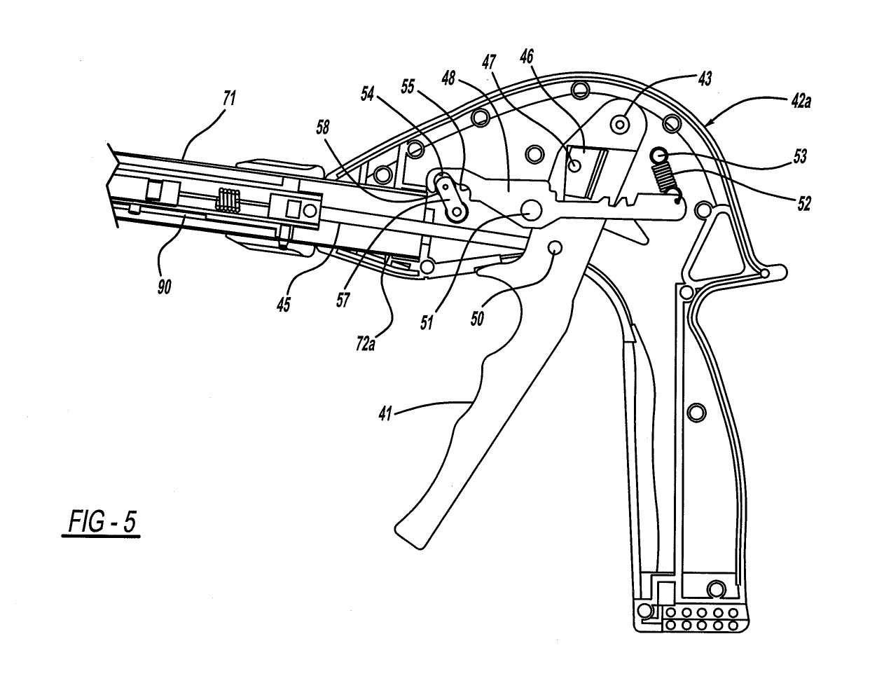

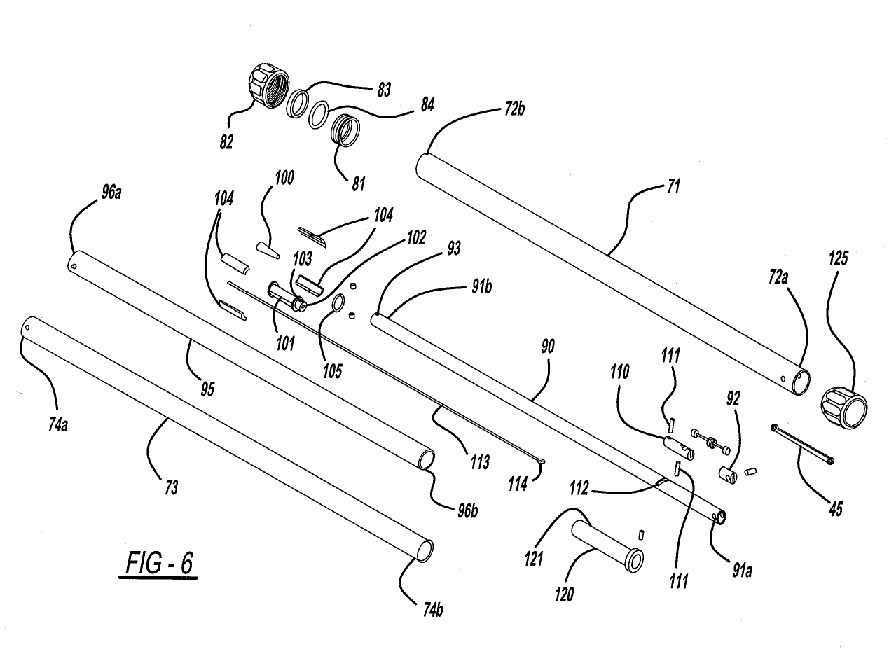

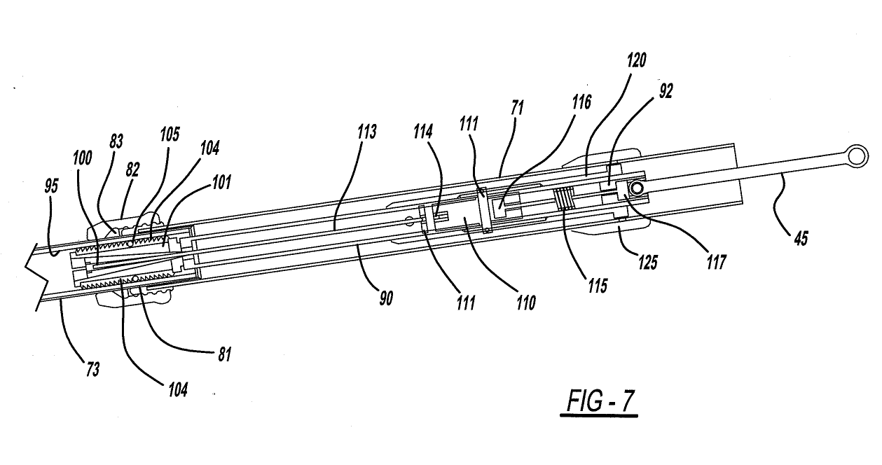

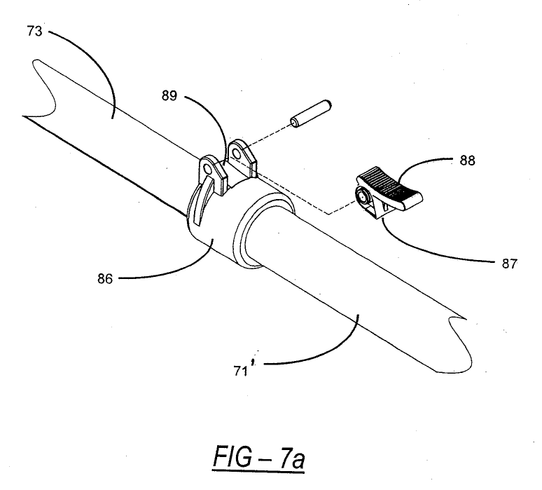

With continuing reference to FIGS. 1, 6 and 7, the first 71 and second 73 tubular members are connected to one another in a telescoping manner. As such, one of the tubular members (in the illustrated embodiment, the second tubular member 73) is slightly smaller in diameter than the other (in the illustrated embodiment, first tubular member 71), allowing insertion of the one into the other for sliding adjustment. In order to fix the relative positions of the first 71 and second 73 tubular members, a collet assembly 80 is provided. Collet assembly 80 includes an externally threaded collar 81 attached to the proximal end of the first tubular member 71, and a corresponding collet nut 82 seated thereon (FIGS. 6 and 7). As shown best in FIG. 7, collet nut 82 is characterized by an internal surface which tapers toward one end to define an increasingly smaller internal diameter of the collet nut 82. Provided over the end of the second tubular member 73 and captured by the collet nut 82 are a cylindrical wedge 83 and an O-ring 84. By tightening the collet nut 82 onto collar 81, the wedge 83 is increasingly urged by the tapered internal surface into engagement with the second tubular member 73 to thereby restrain the second tubular member 73 against sliding with respect to the first tubular member 71. Conversely, loosening the collet nut 82 will correspondingly disengage the wedge 83 from the second tubular member 73 and so permit sliding movement of the second tubular member with respect to the first tubular member 71.

According to an alternative embodiment, shown in FIG. 7a, the first 71′ and second 73′ tubular members may be connected to one another in a telescoping manner by means of a manually-operated cam lever. As is known to those skilled in the art, this mechanism comprises a collar member 86 disposed at the first end of the first tubular member 71′, the collar member pivotally supporting a manually actuated lever 87 having a cam surface 88. Cam surface selectively acts against a wedge 89 provided on the collar member 86 to effect frictional engagement between wedge 89 and the outer surface of second tubular member 73′. More specifically, when the lever 87 is in a first, lowered position (shown in FIG. 7a), cam surface 88 acts to urge wedge 89 into engagement with the outer surface of the second tubular member 73′, thereby fixing the relative positions of the first 71′ and second 73′ tubular members. When the lever 87 is manually pivoted into its raised position (not shown), cam surface 88 is rotated out of engagement with wedge 89, which in turn moves out of engagement with the outer surface of the second tubular member 73′.

Referring again to FIGS. 6 and 7, the construction and operation of the telescoping pull member according to a first exemplary form will be better understood.

According to this form, pull member generally comprises first 90 and second 95 pull tubes, one of the pull tubes (in the illustrated embodiment, the first 90 pull tube) being of smaller diameter than the other so as to be slidingly telescoping receivable therein.

Pull member is interconnected with the jaw and handle portions such that manual actuation of the trigger 41 effects movement of the jaws 11a, 11b. As described above, interconnection of carriage assembly pull rod 29 with a mount 75 secured in a first end 96a of second pull tube 95 operatively interconnects the pull member with the jaw portion 10 (see FIG. 3). Oppositely, the second end 91a of the first pull tube 90 is interconnected with the trigger 41 via the trigger-connecting pull rod 45, which is associated at one end thereof with the mount 92 secured in the second end 91a of the first pull tube 90 (see FIG. 5).

Concurrently with any adjustment in the length of the telescoping central portion 70, the telescoping pull member must be correspondingly adjusted in length. To this end, there is provided a second coupling for fixing the overall length of the pull member, the second coupling being characterized by a first, engaged condition in which the length of the pull member is fixed, and a second, disengaged condition in which the length of the pull member may be varied. This second coupling, in this first exemplary form of the invention, comprises an expanding mandrel assembly including a cone-shaped wedge 100 moveably disposed within a mandrel body 101 having a complimentarily cone-shaped internal passageway (see FIGS. 6 and 7). The mandrel body 101 is secured at one end thereof to a second end 91a of the first pull tube 90. In the illustrated embodiment in particular, the mandrel body 101 includes a stem portion 102 having a pair of radially oriented bores 103 therein, each bore aligned with a radial opening 93 provided through the first pull tube 90. Pins, set screws, or the like pass through each such opening 93 and into the bores 103.

Disposed about the circumference of the mandrel body 101 are a plurality of radiused members 104 each having a plurality of teeth defined on the exterior surfaces thereof, as shown. An elastic O-ring 105 surrounds these radiused members 104 to maintain the same in place about the mandrel body 101.

Referring specifically to FIG. 7, it will be appreciated that when the cone-shaped wedge 100 is urged into the complimentarily-shaped internal passageway of the mandrel body 101, the mandrel body is forced to expand radially outward, thereby urging the radiused members 104 radially outwards and into engagement with an interior surface of the second pull tube 95. In this first, engaged condition, the first 90 and second 95 pull tubes of the pull member are fixed in position relative to each other. Conversely, movement of the cone-shaped wedge 100 in a direction out of the passageway of mandrel body 101 permits the mandrel body to contract radially inward (being urged by the elastic O-ring 105), thereby withdrawing the radiused members 104 from engagement with the interior surface of the second pull tube 95. In this second, disengaged condition, the first 90 and second 95 pull tubes of the pull member are telescopingly moveable relative to each other to adjust the overall length of the pull member.

To effect changes in the second coupling between the first and second conditions thereof, there is provided a user-actuatable release mechanism positioned remotely from, but operatively connected to, the second coupling. More particularly, and with continuing reference being had to FIGS. 6 and 7, this release mechanism according to the first embodiment of the invention comprises a bayonet cam 110 moveably disposed within the first pull tube 90. The bayonet cam 110 mounts one or more radially extending pins 111, each of which is dimensioned to be slidingly received in its own helical slot 112 defined in the circumferential wall of the first pull tube 90. A connecting rod 113 interconnects the bayonet cam 110 and the wedge 100 at its narrow end. To this end, the connecting rod 113 may be threaded, being threadingly received in a correspondingly threaded passageway in the wedge 100. Of course, other interconnecting means are possible.

At its opposite end, the connecting rod 113 is connected to the bayonet cam 110. As shown, the connecting rod 113 includes an eyelet 114 received within the bayonet cam 110 and dimensioned to receive therethrough one of pins 111 to thus secure the connecting rod in place. Of course, other interconnecting means are possible. A helical spring 115 interconnects the bayonet cam 110 and the trigger pull-rod mount 92. As shown, the spring terminates at opposite ends in bosses 116 and 117, each slidingly received in correspondingly-shaped, radially-oriented openings of the bayonet cam and trigger pull-rod mount, respectively. Being secured at one end to the fixed-position trigger pull-rod mount 92 and at the other end to the moveable bayonet cam 110, the spring 115 biases the wedge 100 into the mandrel body 101 passageway and, thus, biases the second coupling to the first, engaged condition thereof defined above.

A rotatable sleeve 120 is positioned over the first pull tube 90 proximate the location of the bayonet cam 110 within the first pull tube 90, as shown in FIG. 7, the rotatable sleeve 120 defining a pair of longitudinal slots 121 for slidably receiving therein each of the pins 111. The sleeve 120 is fixedly connected to a user-rotatable collar 125 disposed on the exterior surface of the first tubular member 71 by a pin, set-screw, etc. which passes through the circumferential wall of the first tubular member. By user rotation of the collar 125, the sleeve 120 is correspondingly rotated. This, in turn, rotates the associated pins 111, causing them to be driven forward in their respective helical slots 112 and, simultaneously, longitudinally forward in the slots 121 in sleeve 120. This motion drives the connecting rod 113 forward, thereby pushing wedge 100 out of the passageway of mandrel body 101. Conversely, when a user releases collar 125 after rotation thereof, helical spring 115 urges bayonet cam 110 rearwardly, which motion correspondingly causes the sleeve 120 and, by association, the collar 125, to rotate back to their original positions. Relatedly, this motion draws the connecting rod 113 rearward, thereby urging the wedge 100 further into the passageway of mandrel body 101 and so causing radial outward expansion of the radiused members 104 to return the second coupling to its engaged condition.

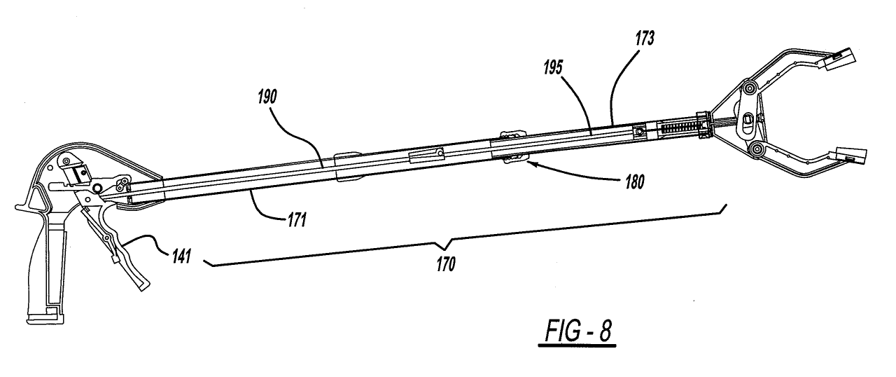

Turning next to FIGS. 8 through 13, there is shown another alternative form of the present inventive reacher. As this form is comparable in numerous respects to the previously-described form in respect of the exemplary configuration of the handle, jaw and central portions, these are not reiterated here except to the extent that they differ from the aforedescribed embodiment.

Referring specifically to FIG. 8, the selectively extendible central portion 170 comprises, as with the other forms of the invention, telescopingly interrelated first 171 and second 173 tubular members. Also as with the other forms, a first coupling in the form of a collet assembly 180 is provided for fixing the relative positions of the first and second tubular members.

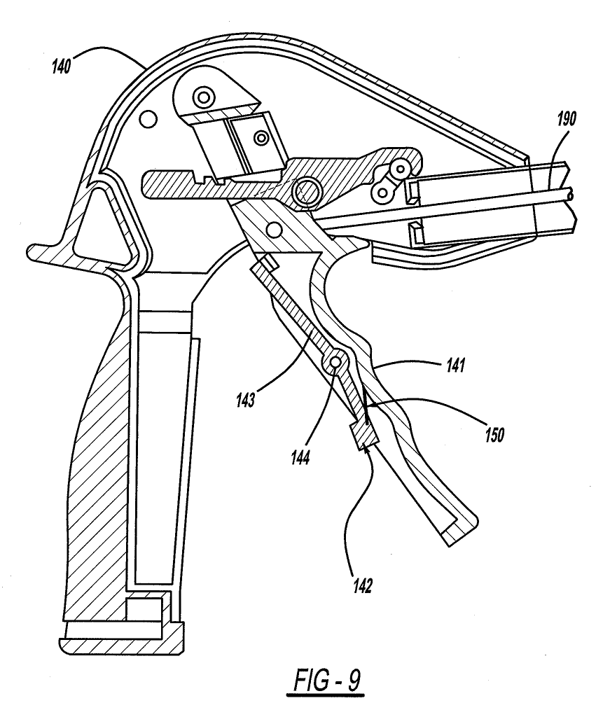

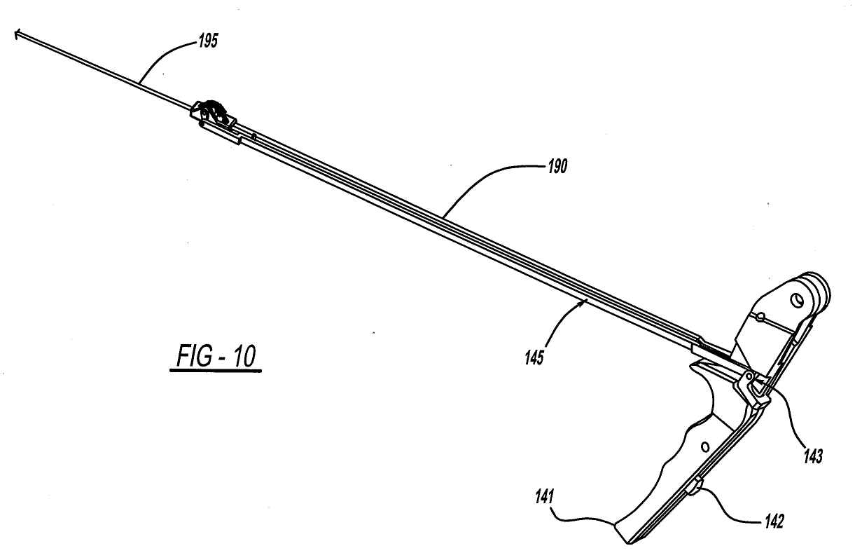

Referring also to FIGS. 9 and 10, the selectively-extendible pull member comprises first 190 and second 195 pull rods, the first pull rod 190 being connected at one end thereof directly to the trigger 141, and the second pull rod 195 being connected at one end thereof to the jaw portion in the manner described previously.

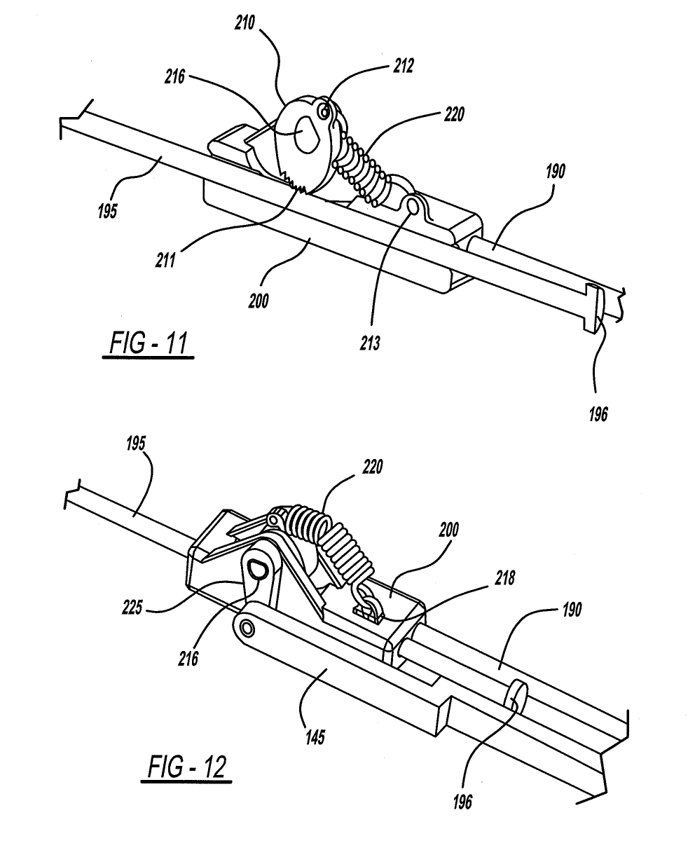

Turning now to FIGS. 11 through 13, the second coupling for fixing the length of the pull member in a manner corresponding to the selected length of the central portion 170 is, according to the second embodiment, a cam-action linkage assembly comprising a body 200 that has a fixed connection with the first pull rod 190 and a sliding connection with the second pull rod 195. The body 200 supports a toothed cam 210 which is selectively engageable with the surface of the second pull rod 195 by means of teeth 211 in order to fix the position of the same relative to the body 200. More particularly, body 200 has a generally rectangular base portion with a passageway 201 extending longitudinally therethrough. Passageway 201 is slightly larger in diameter than the second pull rod 195, so that the second pull rod may be slidingly received therein. A stop 196 defined at an end of the second pull rod 195 prevents the same from being completely withdrawn from the passageway 201. As shown, a slot 202 is formed through an upper surface of the body 200, the slot being in communication with the passageway 201 so as to expose a portion of the length of the second pull rod 195. The first pull rod 190 is fixedly connected to the body 200. For instance, at one end of the body 200 there is provided an aperture 203 is sized to receive an end of the first pull rod 205, the first pull rod being held in place within the aperture 203 by any conventional means such as epoxies or glues, one or more screws, pins, friction fit, etc.

The cam 210 includes a plurality of teeth 211 opposite an ear 212. The plurality of teeth 211 are formed on the radial surface of the cam 210, near the largest diameter thereof, to enhance engagement between the cam 210 and the second pull rod 195. The ear 212 protrudes from the radial surface of the cam 210 and is connected to a tension spring 220. The opposite end of the tension spring 220 is connected to a mounting member 213 provided on the body 200.

In order to support the cam 210 with respect to the body 200, a pair of fins 214 extend outwardly from and substantially perpendicular to the body 200. The fins 214 are located on opposite sides of the slot 202 and spaced parallel to one another at a distance slightly larger than the width of the cam 210 so that the cam may be disposed between the fins 214 and above the slot 202. To this end, corresponding holes 215 extend through each fin 214, and are aligned with one another along a common axis, so that a shaft 216 may extend through the holes 215. The cam 210 is seated on the shaft 216 in the area between the fins 214, and the shaft 216 extends beyond at least one of the fins for connection to a crank arm 225 extending substantially perpendicular to the shaft 216 for rotational movement in unison therewith.

Cam 210 is rotatable on the shaft 216 between an engaged position, wherein the cam 210 extends at least partially into the slot 202 to engage the second pull rod 195 with the teeth 211 of the cam and thereby restrain motion of the second pull rod 195 with respect to the body 200, and a disengaged position, wherein the cam 210 does not engage the second pull rod 195 which is therefore free to slidably move in the passageway 201 with respect to the body 200.

As best seen in FIGS. 9, 10 and 12, the user-actuatable release trigger of this form of the present invention comprises a release button 142 disposed on the trigger 141 of the handle portion 140. Release button 142 is located at the free end of a release lever 143, which is mounted on a pivot post 144 located inside the trigger 141. Opposite the release button 142, the release lever 143 is pivotally connected to a release rod 145 which extends to the adjustable linkage assembly where it is pivotally connected to the crank 225. Depression of the release button 142 is resisted by a spring 150 which exerts a biasing force on the release lever 143. However, when the release button 142 is depressed, the release lever 143 pivots with respect to the pivot post 144 and urges the release rod 145 toward the handle portion 140. This linear motion of the release rod 145 is converted into rotational motion by the crank 225 and the shaft 216, and the cam 210 is thus rotated from a default position wherein the cam teeth 211 are engaged with the surface of the second pull rod 195 and into to a disengaged position. Upon release of the button 142, the biasing forces exerted by the springs 220 and 150 move the cam from the disengaged position and back into the engaged position.

In either of the foregoing forms of the extendible reacher, in the event that the distance between the jaw portion and the handle portion is not appropriate in light of the task contemplated by the user, the user may adjust the length of the central portion by first unscrewing the collet nut of the collet assembly, which disengages the wedge from the second tubular member to thus permit telescoping movement of the first and second tubular members. The user next actuates the release trigger, either by depressing the release button or turning the collar (depending on the form of the invention), which actions cause the second coupling to move from the engaged to the disengaged position. At this point, the pull member may be lengthened or shortened concurrently with telescoping movement of the first and second tubular members. Thus, while depressing the release trigger, the user grasps the second tubular member and changes the distance between the handle portion and the gripping portion as desired. After the desired length is obtained, the user releases release trigger and tightens the collet nut to thereby fix the lengths of each of the central portion and the pull member.

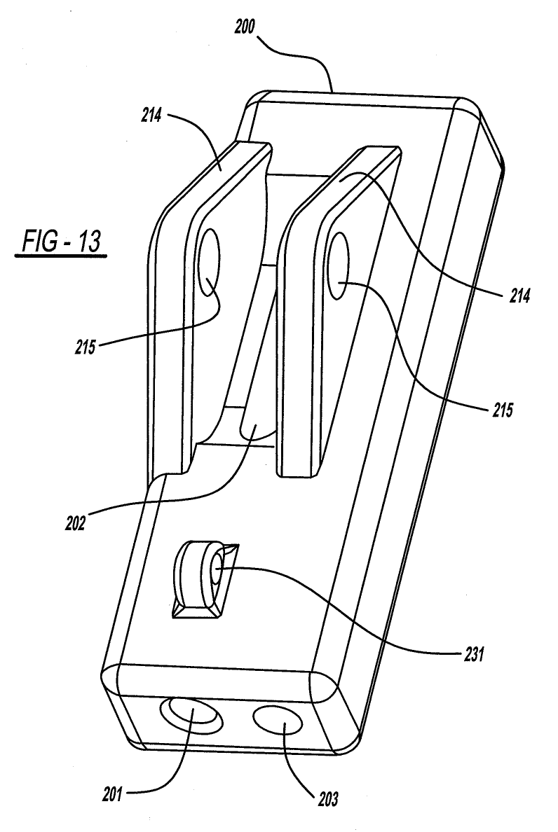

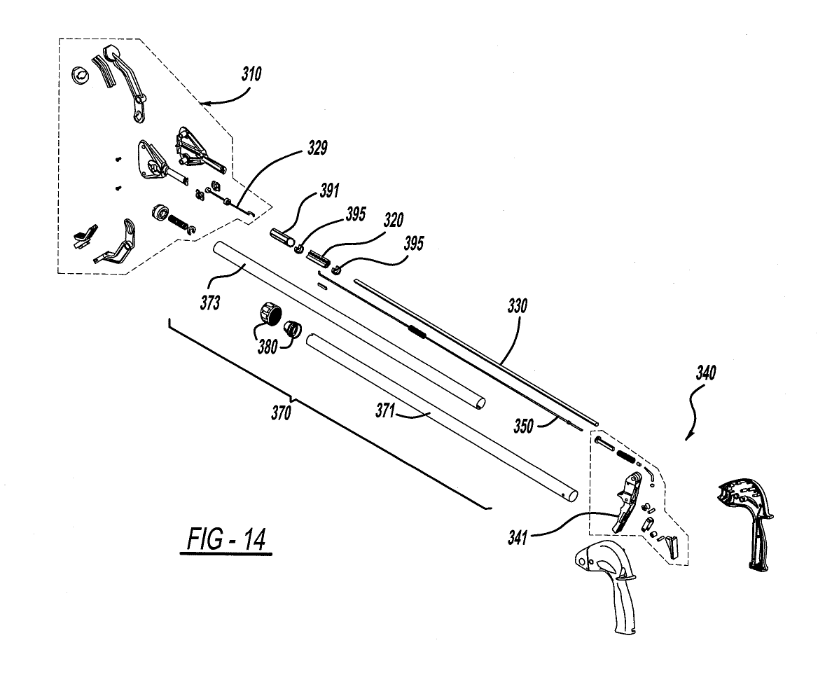

Referring next to FIGS. 14 through 20a, there is shown another embodiment of the inventive reacher wherein selective positioning of the second coupling between the first and second conditions thereof is effected by rotational movement of one of the first or second tubular members of the central portion. Further according to this embodiment, the pull member as shown in the figures comprises a pull rod 350 and a toothed gear rack 330 (FIG. 14). In the first, engaged condition of the second coupling the toothed lock member is in contact with the toothed gear rack to thereby fix the length of the pull member, and in the second, disengaged condition of the second coupling the toothed lock member is out of contact with the toothed gear rack to thereby permit the length of the pull member to be varied.

As this embodiment is comparable in numerous respects to the previously-described forms of the inventive reacher in respect of the exemplary configuration of the handle (shown generally at 340), jaw (shown generally at 310) and central (shown generally at 370) portions (FIG. 14), these are not reiterated here except to the extent that they differ from the aforedescribed embodiment.

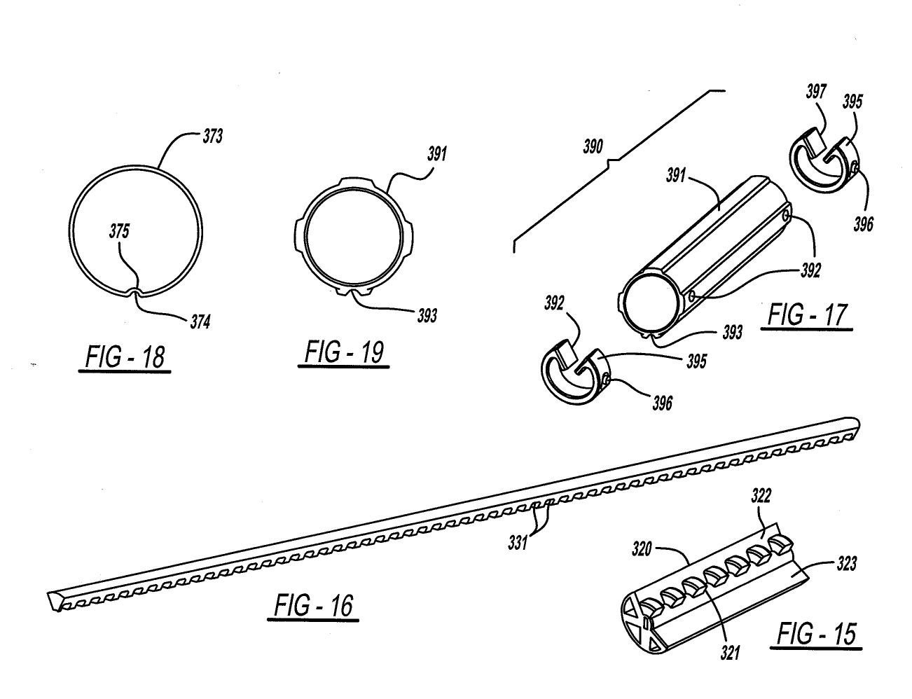

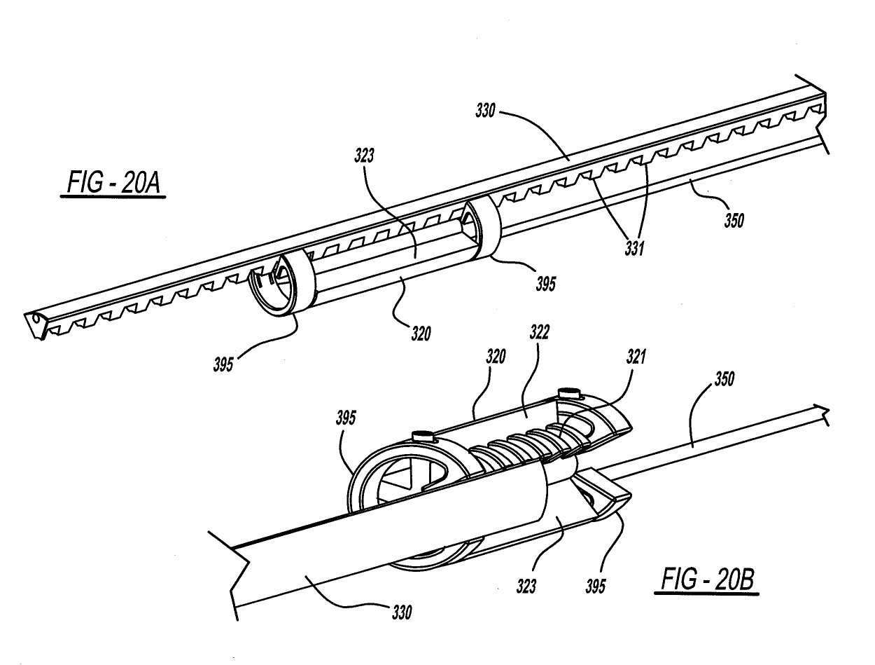

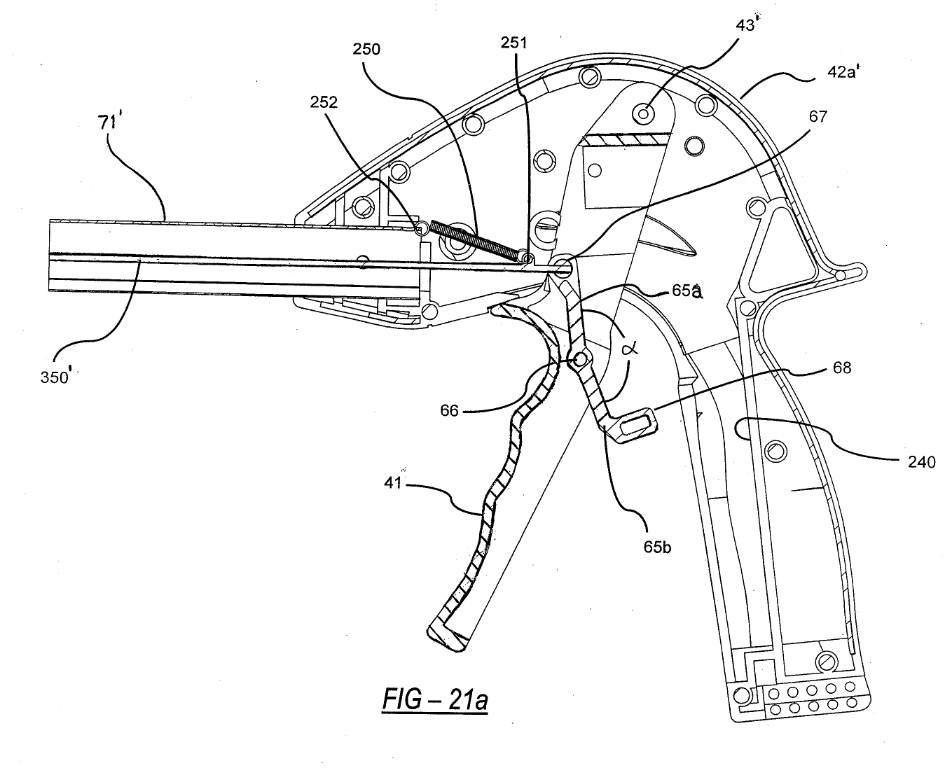

As noted, the second coupling for fixing the length of the pull member in a manner corresponding to the selected length of the central portion 370 is, according to this embodiment, a locking member 320 with a plurality of teeth 321 formed along its length, the teeth of the locking member 320 being selectively engageable with teeth 331 disposed along the length of longitudinal gear rack 330 (see FIGS. 15 and 16). Locking member 320 is fixed to one end of pull rod 350, the second end of the pull rod 350 being secured to trigger 341 so as to be moveable therewith (FIGS. 14, 20a and 20b). Gear rack 330 is operatively connected at one end thereof to the jaw assembly, which may be constructed, for instance, as more particularly shown and described in relation to FIG. 2. More particularly, a carriage assembly pull rod 329 is secured at one end thereof to an end of gear rack 330 (FIG. 14). The opposite end of the gear rack 330 is unattached, extending freely into a locking-member support sleeve 390 comprised of a tubular member 391 having disposed at opposite ends thereof lock rings 395 (FIG. 17). Lock rings 395 are fixed in place at opposite ends of tubular member 381. To this end, each lock ring 395 in the embodiment shown includes a projection 396 extending radially therefrom which is receivable in a correspondingly dimensioned opening 392 provided through the tubular member 391. As shown, each lock ring 395 is characterized by an overall “C”-shape, the terminal ends thereof defining angled surfaces 397. The angled surfaces 397 of each lock ring 395 and the adjacent inner surface of the tubular member 391 collectively define a path for the sliding movement of gear rack 330 relative thereto, and further serve to restrain gear rack 330 in that path.

Referring specifically to FIG. 15, locking member 320 is characterized by a semi-circular cross-section the radial surfaces 322, 323 of which are disposed at an obtuse angle relative to each other. A first one of these surfaces 322 is wider than the other and bears the plurality of teeth 321 that, as depicted, project upwardly from that surface 322.

As with the other forms of the inventive reacher, the reacher of this embodiment comprises a selectively extendible central portion 370 including a first tubular member 371 slidingly telescopingly received within a second, larger-diameter tubular member 373. In order to fix the relative positions of the first 371 and second 373 tubular members, there is provided a collet assembly 380 as previously described.

The tubular member 373 has a smaller diameter than tubular member 371, and includes a longitudinally extending, U-shaped groove 374 formed in the outer surface and which forms an inwardly projecting, longitudinally extending rib 375 on the inner surface (FIG. 18). As shown best in FIG. 19, tubular member 391 includes a longitudinally extending, U-shaped groove 393 formed in the outer surface thereof, the groove 383 being dimensioned to slidingly receive therein the longitudinally extending rib 375 of the tubular member 373 when tubular member 391 is disposed coaxially within tubular member 373. By the foregoing construction, it will be appreciated that tubular member 373 is capable of sliding movement relative to tubular member 391 while rotational alignment is maintained.

Telescopic adjustment according to this embodiment of the invention is achieved by loosening the collet nut of collet assembly 380 (or, according to the alternative embodiment, the cam lever XX), following which the tubular member 373 is rotated in a first direction about its longitudinal axis. By reason of the engagement between the rib 375 projecting inwardly from tubular member 373 and the channel 393 in tubular member 391, rotation of tubular member 373 simultaneously rotates tubular member 391 and the associated lock rings 395. This motion carries the gear rack 330 (which is captured in the path defined by the inner wall of tubular member 391 and the locking rings 395 as heretofore described) out of engagement with the locking member 320 (FIG. 20b), thereby permitting subsequent telescoping movement of the tubular members 371, 373 relative to each other to a desired length. When the desired overall length is reached, tubular member 373 is rotated in the opposite direction about its longitudinal axis, this motion carrying the gear rack 330 back to its original position and so bringing teeth 331 into engagement with the teeth 321 of locking member 320 (FIG. 20a) to thereby fix the length of the pull member. By thereafter tightening the collet nut of the collet assembly 380, the reacher is fixed at its new length until further adjustments are desired.

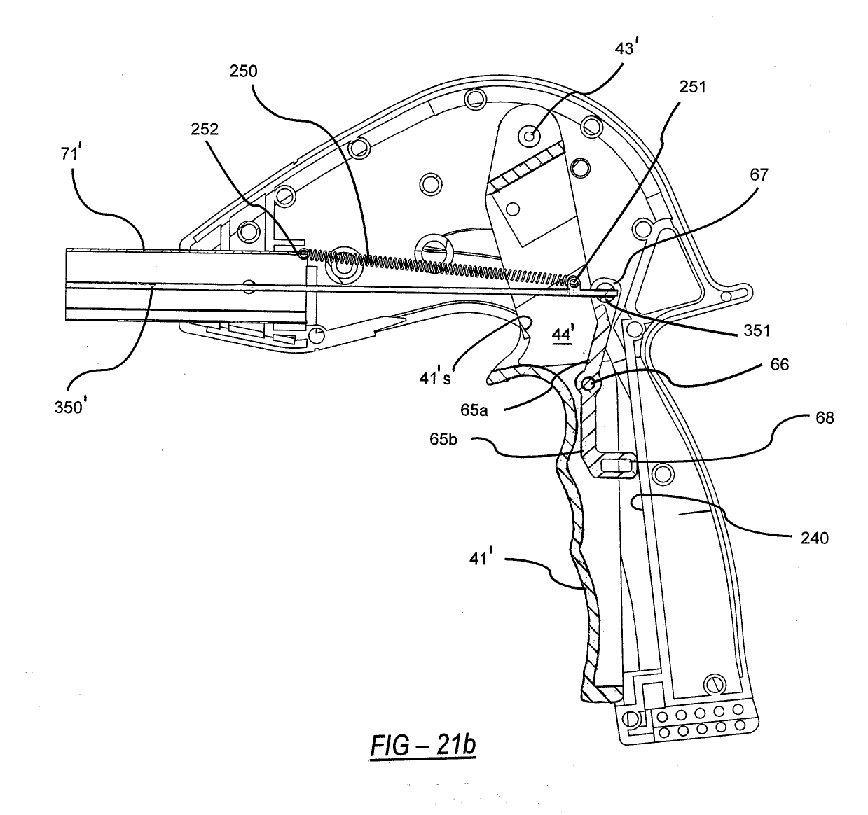

Referring next to FIGS. 21a and 21b, there is shown in cross-section an alternative embodiment of a handle portion 40′ that is, except as otherwise described hereinbelow, essentially as the handle of FIGS. 1, 4 and 5. This embodiment of handle portion 40′ is particularly, though not exclusively, suited to employment in an extendible reacher incorporating mechanism of FIGS. 14 through 20b, and provides means for augmenting rearward movement of the pull rod 350′ in response to actuation of the manually-actuatable trigger 41′ to thus permit a larger distance between the jaws in the fully opened position thereof.

Though not depicted in FIGS. 21a and 21b, a locking mechanism such as heretofore described may be provided to fix the pivotal position of the trigger 41′, and thereby fix the relative positions of the jaws (not shown) between the fully open and fully closed positions thereof.

The means for augmenting rearward movement of the pull member more particularly include a fulcrum lever 65 pivotally disposed on the handle 41′ and connected to the pull rod 350′. Fulcrum lever 65 is, as depicted, characterized by a pair of arms 65a and 65b extending oppositely from a central opening where the lever 65 is rotatably mounted on a pivot 66 disposed on the trigger 41′. Arms 65a and 65b define, as shown, an angle α that may be of any measurement suitable to achieving the ends herein described. Angle α may, for example, be an obtuse angle of approximately 165°, as shown. Arm 65a terminates at end 67 that is connected to an end of the pull rod 350′ by a ferrule 351′ so that the lever 65 is rotatable relative thereto during pivotal movement thereof. Oppositely, at the end of arm 65b, there is provided a projection 68 directed inwardly toward the body of handle 40′.

Trigger 41′ is pivotally mounted to trigger pivot shaft 43′. Trigger 41 includes an opening 44′ therethrough to accommodate pull rod 350′. Proximate the bottom of opening 44′ there is defined a stop surface 44′s for abutting an opposing surface 69 defined at the end 67 of arm 65a.

Further according to this embodiment, it may be seen that a spring 250 is secured at opposite ends to the pull member (at 251) and an end of the first tubular member 71. As described below, spring 250 serves to bias the pull rod (and, by association, the trigger 41′) in the position thereof corresponding to the fully opened position of the jaws.

With continuing reference to both FIGS. 21a and 21b, operation of the foregoing means may be better understood. From the position wherein the jaws are fully opened (FIG. 21a), a user manually depresses trigger 41′ to retract the pull rod 350′ and thereby move the jaws toward each other. More specifically, trigger 41′ pivots rearwardly about pivot shaft 43′, carrying with it the fulcrum lever 65 and pull member 350′ associated therewith. As trigger 41′ is moved rearwardly, the projection 68 comes into contact opposing wall 240 of the handle housing half 42a′. At this limit of the rearward movement of the projection 68, further rearward movement of trigger 41′ causes rotation of the fulcrum lever 65 about pivot 66 so that the arm 65a is driven rearwardly along with the pull rod 350′ (FIG. 21b). In this condition, it will be seen that spring 250 is in tension, such that the pull rod is urged forwardly upon release of trigger 41′.

As with the other embodiment, it will be understood that the foregoing handle portion construction is intended as exemplary only, and that those of skill in the art are free to adapt the handle portion construction as desired, consistent only with facilitating operation of the extendible nature of the reacher as hereinafter described.

A variety of materials may be used in constructing present invention. Except where otherwise indicated in this disclosure, the materials used for the pieces in the present embodiments are generally of a substantially rigid nature. Whether these materials be hardened plastic polymers or any of various substantially non-malleable metals is a matter of design choice and cost effectiveness.

It will be appreciated from the above disclosure that the present invention improves upon the prior art by providing an extendable reacher that is robust yet simple in design, and that allows easy adjustment of the distance between the handle assembly and the gripping assembly.

While embodiments of the invention have been illustrated and described, it is not intended that these embodiments illustrate and describe all possible forms of the invention. Rather, the words used in this specification are words of description rather than limitation, and it is understood that various changes may be made without departing from the spirit and scope of the invention

The invention in which an exclusive property or privilege is claimed is defined as follows:

1. A hand-held reacher, comprising:
A jaw portion comprising a pair of jaws movable relative to each other between fully clamped and fully opened positions thereof;
A handle portion spaced apart from the jaw portion by a selectively extendible central portion, the handle portion comprising a manually-actuatable trigger operatively connected to the jaw portion by a selectively extendible pull member at least substantially disposed within the central portion, whereby actuation of the trigger is operative to move the pull member to thereby selectively position the pair of jaws between the fully clamped and fully opened position thereof;
The selectively extendible central portion comprising a first tubular member slidingly telescopingly received within a second tubular member;
A first coupling for selectively fixing the relative positions of the first and second tubular members; and
A second coupling for selectively fixing the length of the pull member, the second coupling being characterized by a first, engaged condition in which the length of the pull member is fixed, and a second, disengaged condition in which the length of the pull member may be varied.

2. The hand-held reacher of claim 1, further comprising a user-actuatable trigger positioned remotely from the second coupling, the trigger being operatively connected to the second coupling to selectively vary the second coupling between the first and second conditions thereof.

3. The hand-held reacher of claim 2, wherein the pull member comprises a first pull tube slidingly telescopingly received within a second pull tube, and the second coupling comprises a selectively radially expandable mandrel disposed within the second pull tube, the mandrel being characterized by a first, engaged condition in which the mandrel is radially expanded into engagement with the interior surface of the second pull tube to thereby fix the length of the pull member, and a second, disengaged condition in which the mandrel is radially contracted out of engagement with the interior surface of the second pull tube to thereby permit the length of the pull member to be varied.

4. The hand-held reacher of claim 3, wherein the user-actuatable trigger comprises a manually operable release trigger positioned on the second tubular member proximate the handle, the release trigger being operatively connected to the expanding mandrel via a connecting rod.

5. The hand-held reacher of claim 4, wherein the radially expandable mandrel comprises a mandrel body having a tapered interior passageway, a plurality of radially-moveable elements disposed about the exterior circumference of the mandrel body, and a tapered wedge dimensioned for movement within the tapered interior passageway of the mandrel body.

6. The hand-held reacher of claim 5, wherein the connecting rod of the user-actuatable trigger is connected to the tapered wedge, and wherein further actuation of the user-actuatable trigger is operative to move the tapered wedge within the interior passageway of the mandrel body.

7. The hand-held reacher of claim 6, wherein the first coupling for selectively fixing the relative positions of the first and second tubular members comprises a collet disposed proximate an end of the first tubular member, and a collet nut threadingly engageable thereon.

8. The hand-held reacher of claim 2, wherein the pull member comprises first and second pull rods, and the second coupling comprises a cam body supporting a cam;
wherein the first pull rod is fixedly connected to the cam support body, and the second pull rod is slidingly associated with the cam support body; and
wherein further the cam is characterized by a first, engaged condition in which the cam is in contact with the second pull rod to thereby fix the length of the pull member, and a second, disengaged condition in which the cam is out of contact with the second pull rod to thereby permit the length of the pull member to be varied.

9. The hand-held reacher of claim 8, wherein the user-actuatable trigger comprises a manually operable release trigger provided on the handle portion, the release trigger being operatively connected to the cam via a connecting rod.

10. The hand-held reacher of claim 9, wherein the cam body includes a first passageway through which is slidingly received the second pull rod, wherein the cam is pivotally mounted on the cam body, and wherein further the passageway includes an opening through which the cam can be brought into engagement with the second pull rod in the first, engaged position of the first coupling.

11. The hand-held reacher of claim 10, wherein the cam is biased toward engagement with the second pull rod via the opening in the cam body, and wherein further actuation of the user-actuatable trigger is operative to move the cam out of the passageway opening in the cam body and out of engagement with the second pull rod.

12. The hand-held reacher of claim 8, wherein the first coupling for selectively fixing the relative positions of the first and second tubular members comprises a collet disposed proximate an end of the first tubular member, and a collet nut threadingly engageable thereon.

13. The hand-held reacher of claim 1, wherein selective positioning of the second coupling between the first and second conditions thereof is effected by rotational movement of one of the first or second tubular members of the central portion.

14. The hand-held reacher of claim 13, wherein the pull member comprises a pull rod and a toothed gear rack, and the second coupling comprises a toothed lock member;
wherein the pull rod is fixedly connected to the toothed lock member; and
wherein in the first, engaged condition of the second coupling the toothed lock member is in contact with the toothed gear rack to thereby fix the length of the pull member, and in the second, disengaged condition of the second coupling the toothed lock member is out of contact with the toothed gear rack to thereby permit the length of the pull member to be varied.

15. The hand-held reacher of claim 14, wherein the pull rod is operatively connected to the manually-actuatable trigger, and the gear rack is operatively connected to the jaw portion.

16. The hand-held reacher of claim 13, wherein the gear rack is slidably received in, and rotatably fixed relative to, a housing disposed within, and rotatably fixed relative to, one of the first or second tubular members of the central portion; and
wherein rotational movement of one of the first or second tubular members of the central portion in a first direction is operative to rotate the housing and carry toothed gear rack out of engagement with the toothed locking member to thereby define the second condition of the second coupling, and rotational movement of the said one of the first or second tubular members of the central portion in a second direction is operative to rotate the housing and carry toothed gear rack into from a position of disengagement with the toothed locking member back into engagement with the toothed locking member to thereby define the first condition of the second coupling.

17. The hand-held reacher of claim 16, wherein the locking member is positioned with the said housing.

18. The hand-held reacher of claim 17, wherein the first coupling for selectively fixing the relative positions of the first and second tubular members comprises a collet disposed proximate an end of the first tubular member, and a collet nut threadingly engageable thereon.
